(19) United States
(12) Patent Application Publication
(10) Pub. No.: US 2026/0264061 A1
(43) Pub. Date: Sep. 10, 2026

(54) Process and catalyst for the production of hydrogen by decomposition of ammonia by plasma catalysis

(71) Applicant: ENERGO, Loos (FR)

(72) Inventors: Maria MIKHAIL; Johnny ABBOUD

(73) Assignee: ENERGO, Loos (FR)

(21) Appl. No.: 18/843,199

(22) PCT Filed: Mar. 7, 2023
(86) PCT No.: PCT/IB2023/052121

§ 371 Date: Aug. 30, 2024

(30) Foreign Application Priority Data
Mar. 7, 2022 (FR) FR2201960
Jun. 29, 2022 (FR) FR2206576

(51) Int. Cl. B01J 23/755; B01J 21/04; B01J 23/78; B01J 23/83; B01J 23/889; B01J 35/30; C01B 3/047

(52) U.S. Cl. CPC B01J 23/755; B01J 21/04; B01J 23/78; B01J 23/83; B01J 23/8892; B01J 35/394; C01B 3/047

(57) ABSTRACT

The present invention relates to a process for converting a gas comprising NH3 in the presence of a cold plasma, preferably a plasma generated by dielectric barrier discharge (DBD), and of a catalyst comprising a support comprising alumina, nickel, and at least one promoter comprising iron. The invention also relates to such a catalyst, and to the use thereof for producing high value-added molecules like hydrogen (H₂).

### TECHNICAL FIELD

The present invention belongs to the field of chemical conversion, in particular the conversion of a gas or a mixture of gases comprising ammonia (NH₃) to produce dihydrogen (H₂) and dinitrogen (N₂). In particular, the invention relates to the process of conversion of NH₃ into H₂ and N₂, in the presence of a catalyst and a cold plasma, for example generated by dielectric barrier discharge, so-called DBD, thereby enabling chemical conversion via plasma-catalysis. The invention also relates to said catalyst, to the process of preparation of this catalyst and to the use of the catalyst for converting ammonia and producing a high value-added molecule such as hydrogen.

### PRIOR ART

With the considerable increase in energy demand and the impact of fossil fuels on the environment, the search for new energy resources is receiving increasing attention.

Hydrogen fuel is perceived as an ideal candidate for solving the energy and environmental crisis. Moreover, its use in fuel-cell vehicles is particularly promising for controlling COₓ and NOₓ emissions in the environment originating from conventional fossil fuels. Hydrogen has a higher energy density (142 MJ/kg) than the other fuels. In addition, this molecule is easily available in water and in gaseous hydrocarbon fuels. Many studies have examined the hydrogen production methods such as steam reforming and water fractionation [1].

The ammonia (NH₃) gas is a promising candidate for the transport and storage of hydrogen. Furthermore, 150 Mt of NH₃ are produced each year and used throughout the world. Because of its storage characteristics, NH₃ is more advantageous than the other energy vectors of hydrogen: on the one hand, NH₃ has a higher gravimetric density than the other fuels; on the other hand, the cost of the energy stored per volume of NH₃ is three times as low as that of hydrogen. In particular, ammonia decomposition is used in at least two different fields related to energy and environment sciences: it may in particular be used to supply COₓ-free hydrogen to fuel cells and it may also be used to remove ammonia from the reformate of internal gasification combined-cycle (IGCC) power plants, which technology could be widely deployed in the future as a CO₂ removal way.

In recent years, the decomposition of NH₃ has received great attention because of its potential use in the production of H₂ without COₓ for fuel cells. The conventional heterogeneous catalysis according to equation 1 (Eq. 1) has, to date, been the primary way for decomposition of NH₃ [1], [2], [3].

$${NH}_{3} ( g ) \to \frac{1}{2} {N}_{2} ( g ) + \frac{3}{2} {H}_{2} ( g ) Δ {H}_{298 K} = 54 kj / mol \qquad ( Eq . 1 )$$

Given the high chemical stability of NH₃, conventional thermal catalysis processes require high gas pressures as well as a significant amount of energy (thermal energy), in particular temperatures in the range of 500° C. to 800° C., to promote the activation of the catalyst, shifts the thermodynamic equilibrium and guarantee acceptable yields. The high-temperature catalytic reactions not only result in a high energy consumption, but also in a potential deactivation of the catalyst because of sintering of the metal active sites and the formation of coke at the surface of the catalyst. In general, the thermal processes are catalyzed by noble metals, such as Ir, Pd, Pt, Rh and Ru, in stable operation. The noble metal ruthenium (Ru) has the best catalytic activity for the decomposition of ammonia, but its cost and its scarcity limit commercialization thereof on a large scale. Unfortunately, the very slow rate of recombinant desorption of the nitrogen atoms (N_{ads}) adsorbed at the surface of low-cost metal catalysts inhibits the entire ammonia decomposition process, unless the reaction is performed at high temperature (about 500° C.-800° C.) [1], [2], [3].

Consequently, the search for new processes capable of operating at low temperatures and for catalysts that are stable depending on the temperature is of great interest.

Different studies have been carried out to develop technologies for chemical synthesis by cold plasma, allowing overcoming the aforementioned temperature problems. Among these technologies, the dielectric barrier discharge (DBD), in particular coupled with the presence of a heterogeneous catalyst (plasma-catalysis), has been described [4], [5].

Different catalytic systems, plasma types, experimental variables and reactors have been tested in the prior art in order to improve the conversion of ammonia. However, the efficiency of these systems remains low. Moreover, the activity, the stability and the costs of the described catalysts have proved to be incompatible with industrial use [6], [7].

In particular, an object of the present invention is to provide a process for chemical conversion of ammonia (NH₃) in the presence of a catalyst which has high catalytic and energy yields, and adapted to be exploited on a large scale, the objective consisting in obtaining hydrogen (H₂), while avoiding resorting to the use of noble metals.

None of the documents [6], [7], [8], [9], [10], or describes a process for converting ammonia (NH₃) by plasma-catalysis in the presence of a cold plasma and a catalyst comprising a support based on alumina, nickel and at least one promoter comprising iron (Fe).

### SUMMARY OF THE INVENTION

A first object of the present invention is a process for converting a gas or a mixture of gases comprising ammonia (NH₃) into dihydrogen (H₂) and dinitrogen (N₂) according to the following reaction: NH₃→3/2 H₂+1/2 N₂, said process being carried out in the presence of cold plasma and a catalyst comprising a support comprising alumina, nickel (Ni), and at least one promoter comprising iron (Fe).

A second object of the present invention is a catalyst, also so-called catalytic system, allowing converting a gas or a mixture of gases comprising ammonia (NH₃) into dihydrogen (H₂) and dinitrogen (N₂), said conversion being carried out in the presence of a cold plasma, characterized in that the catalyst comprises a support comprising alumina, nickel, and at least one promoter comprising iron (Fe). This catalytic system, which may, for example, be activated by a DBD plasma, allows solving all the drawbacks of the prior art present in the thermal process (high temperature and pressure) and capable of synthesizing H₂ from NH₃ under atmospheric conditions with a high yield with regards to the studies described in the prior art.

According to a preferred embodiment, said catalyst comprises:
a support comprising alumina,
nickel,
a promoter comprising iron (Fe), and
optionally at least one second promoter:
   of the transition-metal type, and more particularly a promoter comprising cobalt (Co), manganese (Mn), copper (Cu) or silver (Ag);
   of the lanthanide type, and more particularly a promoter comprising lanthanum (La), cerium (Ce) or gadolinium (Gd);
   of the alkaline-earth type, and more particularly a promoter comprising barium (Ba); and/or
   of the alkali metal type, and more particularly a promoter comprising potassium (K).

A third object of the present invention relates to a process for preparing such a catalyst.

A fourth object of the present invention relates to the use of the catalyst according to the present invention for the conversion of a gas or a mixture of gases comprising ammonia (NH₃), said conversion being carried out in the presence of cold plasma, preferably a plasma generated by dielectric barrier discharge (DBD)

The present invention allows overcoming all the drawbacks of conventional thermal catalysis processes, as described in the prior art, and thus obtaining high catalytic and energy efficiencies, and could thus be exploited on a large scale.

### DESCRIPTION OF THE FIGURES

Other features, aims and advantages of the invention will appear from the following description, which is merely illustrative and non-limiting, and which could be read with reference to the appended drawings: FIG. 1 GC chromatogram of the inlet gas before reaction by associating the catalytic system 5Ni10FeAl with the DBD plasma catalytic reactor. FIG. 1 illustrates a GC chromatogram of the inlet gas (containing 100% NH₃) in a DBD reactor coupled with the catalyst 5Ni10FeAl.

FIG. 2 GC chromatogram of the outlet ammonia gas after reaction by associating the catalytic system 5Ni10FeAl with the DBD plasma catalytic reactor. FIG. 2 illustrates a GC chromatogram of the ammonia gas remaining following the conversion of NH₃ in a DBD reactor coupled with the catalyst 5Ni10FeAl.

[Table 1] Table showing the catalytic activity (i.e. conversion, selectivity) obtained for several catalysts according to the invention and comparative catalysts, tested in DBD plasma.

### Definitions

In the context of the present invention:
the expression “comprised between . . . and . . . ” (for example, a range of values) should be understood as including the bounds (for example, the limit values of this range of values);
any description relating to an embodiment is applicable and interchangeable with all of the other embodiments of the invention;
the expression “and/or” should be understood as meaning “and” and “or”; for example, the expression “A” and/or “B” should be understood as meaning either A and B, or A alone, or B alone;
the expression “N, M and/or P” should be understood as meaning “N and/or M and/or P”;
the expression “N, M and P” should be understood as meaning “N and M and P”;
in the case where an element or a component is included in and/or selected from a list of elements or components, it should be understood that this individual element or component may be selected and combined with other individual elements, or may be selected so as to form a sub-group of two or more elements or components explicitly listed; also, any element or component cited in a list of elements or components may be omitted from this list.

In the present invention, the term “DBD-dielectric barrier discharge” describes an electrical discharge created between two electrically conductive elements separated by one or more dielectric elements.

In the present invention, the term “dielectric” describes an electrically insulating material that provides electrical insulation between the high-voltage network associated with the electrode and the electrically and thermally conductive tube connected to ground via the reactor. This type of electrically-insulating material is also used inside the DBD cell in order to generate a Dielectric Barrier Discharge (DBD) plasma by promoting accumulation of electrical charges over the surface of this material.

The term “catalyst” and “catalytic system” are interchangeable and refer, in the present invention, to a material promoting the chemical reaction of the reactive species, for example reagent fluids.

The term “plasma-catalysis” refers, in the present invention, to the process that implements an electrical discharge of plasma coupled to a catalyst.

The term “hydrogen” should be understood as meaning dihydrogen (H₂).

The term “support” or “support of the catalyst” refers, in the present invention, to a solid material or a mixture of solid materials-which may in particular be characterized by its specific surface area, over which the promoter(s) is (are) deposited.

The term “promoter” or “promoter of the catalyst” refers, in the present invention, to a solid material or a mixture of solid materials added at the surface of the support material, generally in small amounts, intended to increase the efficiency and the performances of the catalyst.

Of course, the invention is described in the foregoing as an example. It should be understood that a person skilled in the art is capable of carrying out different variants of the invention yet without departing from the scope of the invention.

### DETAILED DESCRIPTION OF THE INVENTION

### Process for Converting a Gas Comprising NH₃

A first object of the present invention relates to a process for converting a gas or a mixture of gases comprising ammonia (NH₃) into dihydrogen (H₂) and dinitrogen (N₂) according to the following reaction: NH₃→3/2 H₂+1/2 N₂, said process being carried out in the presence of cold plasma and a catalyst comprising:
a support comprising alumina,
nickel, and
at least one promoter comprising iron (Fe).

The gas that is considered herein comprises NH₃ and may also comprise other chemical species. Thus, this may consist in converting a gas or a mixture of gases comprising NH₃. This method aims to produce high value-added molecules, in particular in the form of gas. Indeed, the process of the present invention allows generating dihydrogen (H₂), dinitrogen (N₂) or mixtures thereof, in the form of gas. The product derived from the process of the invention may also be in another form, for example partially liquid or anhydrous. In this case, it may consist of hydrazine, ammonium nitrate and/or ammonia.

According to the present invention, the process for converting the gas comprising NH₃ is therefore carried out in the presence of a catalyst, as well as a cold plasma, preferably a plasma generated by dielectric barrier discharge (DBD). During the implementation of the process of the invention, the catalyst is activated by the cold plasma. The synergy of the plasma catalysis in this process features a great potential for the direct synthesis of H₂, a high value-added gas, from NH₃. Said catalyst comprising a support comprising alumina, nickel, and at least one promoter comprising iron (Fe) used in the context of the present conversion, in combination with a cold plasma, is more particularly described hereinafter. Thus, the process of the invention is carried out in the presence of a cold plasma-activated catalyst. It should be noted that all of the features described in connection with said catalyst are applicable to the conversion process of the present invention.

According to one embodiment, the selected catalyst is placed between the electrodes of the DBD reactor, enabling the gaseous species to circulate, and is activated by high-voltage electrical discharges (in the range of kV) for a time period in the range of nanoseconds to microseconds. This polarization, combined with the adsorption, the desorption and the catalyst/gas interaction, gives rise to the formation of the plasma as well as activation thereof and the production of hydrocarbons. The electrical energy supplied to the fixed bed in the form of a sinusoidal or pulsed high voltage creates multiple currents on the HV (high voltage) carrier waves, during the positive and negative polarization. These streamers from a few hundred picoseconds to a few tenths of nanoseconds are responsible for the negative or positive polarization of the catalytic sites.

Before the conversion, in particular hydrogenation, step, the catalytic system according to the invention, in the case where its components are in an oxidized form, is advantageously reduced in situ under cold plasma, preferably a DBD plasma, under H₂ as a discharge gas.

The catalytic system according to the invention is activated by creating at the catalytic system (more particularly between the grains of said catalytic system) or proximate thereto (upstream or downstream of the catalytic system, in the gas flow) a strong electric field, typically between 10³ and 1010 V/m, which may vary over time. This strong electric field enables the ionization of a portion of the gas and the excitation of atoms and molecules present in the gas phase. The walls of the reactor are made of a metal material; alternatively, in the case where a DBD plasma is used, the walls of the reactor are made of a dielectric material such as quartz, alumina or ceramic. Advantageously, the reactor may be cylindrical shaped. Besides the creation of a cold plasma state, the created strong electric field is responsible for the negative or positive polarization of the catalytic sites. This polarization induces adsorption and desorption reactions, including at low temperatures (for example at temperatures lower than 400° C., or lower than 350° C.). According to the conventional method without polarization, the working temperature is higher, generally in the range of 500° C. to 800° C.

In particular, the reactor comprises at least one inlet enabling supply thereof with gas to be converted, i.e. a gas (or a mixture of gases) comprising NH₃, and an outlet for discharging the formed products, which are also in the form of gas.

In a variant of the invention, the catalytic system of the invention is activated by a DBD plasma by supplying an electric power lower than 20-35 W/g of catalytic system (namely the catalytic system present in the reactor, i.e. in the catalytic bed).

Advantageously, the conversion reaction is carried out at a pressure close or equal to the atmospheric pressure (10⁵ Pa), for example at a pressure between 1.10⁴ Pa and 3.10⁵ Pa. The conversion reaction may be carried out under pseudo-adiabatic conditions, i.e. with no thermal insulation and with no external heating, or under adiabatic conditions, i.e. with thermal insulation and with no external heating, or under isothermal conditions, i.e. with thermal insulation and/or external heating. The DBD plasma is generated by application of a voltage between the two electrodes comprised between 1 and 25 kV, preferably between 2 and 20 kV, in particular with a frequency comprised between 1 kHz and 100 kHz. In particular, the gas hourly space velocity (GHSV) is comprised between 1,000 h⁻¹ and 150,000 h⁻¹, preferably it is lower than 100,000 h⁻¹.

Optionally, a cooling system is present between the container intended to receive the products generated by the conversion reaction and the outlet of the reactor so as to condense and remove the liquid that might form during the conversion reaction.

### Catalyst According to the Invention

A second object of the present invention relates to a catalyst allowing converting a gas or a mixture of gases comprising ammonia (NH₃) into dihydrogen (H₂) and dinitrogen (N₂), said conversion being carried out in the presence of a cold plasma, characterized in that the catalyst comprises a support based on alumina, nickel and at least one promoter comprising iron (Fe). This catalytic system, which may for example be activated by a DBD plasma, allows solving all the drawbacks of the prior art present in the thermal process (high temperature and pressure) and capable of synthesizing H₂ from NH₃ under atmospheric conditions with a high yield with regards to the studies described in the prior art.

Preferably, the catalyst of the present invention does not comprise a noble metal, such as ruthenium (Ru), iridium (Ir), palladium (Pd), platinum (Pt) or rhodium (Rh).

As demonstrated in the following examples, the combined use of the catalyst according to the invention and of a cold plasma, preferably a plasma generated by dielectric barrier discharge (DBD), allows producing high value-added molecules, such as hydrogen (H₂), while improving the catalytic performances of the reaction, i.e. the conversion rates of NH₃ and the selectivity to the desired product (H₂).

Hence, the present invention generally relates to a catalyst, comprising:
a support comprising alumina,
nickel, and
at least one promoter comprising iron (Fe).

According to one embodiment, the present invention relates to a cold plasma-activated catalyst.

In the context of the present invention, the terms “catalytic system” and “catalyst” are interchangeable. According to an embodiment of the invention, said catalytic system is so-called a mono/bi-metal catalytic system. It should be noted that the concept of mono-metal system and of bi-metal system relates in particular to the species present in the catalyst without taking account of the used support and nickel. For example, in the case where the catalyst is doped with two promoters, we talk about “bi-metal catalyst”; in the case whe the catalyst is doped with three promoters, we talk about “tri-metal catalyst”.

The support used in the context of the present invention is based on alumina. In particular, it is selected for its ability to adsorb the reagents and more particularly NH₃, for its thermal stability and for its specific surface area. It is also selected for its dielectric properties which could affect the properties of the plasma and modify the DBD discharge behavior of the plasma, the electric field and the electron density because of the dielectric permittivity and the polarization effect that gives rise to the local electric field. The Inventors have realized that the use of a support comprising alumina was particularly advantageous, in particular compared to the supports described in the literature (for example SiO₂), in order to obtain higher catalytic results for the conversion of NH₃.

The support could affect the physicochemical properties (basicity, acidity, reducibility, mobility of oxygen due to the presence of inherent defects present on said surface, etc.), as well as the textural properties (pore volume, pore diameter, specific surface area, etc.) and the electrical properties (permittivity, conductivity, etc.), which, in turn, modulate the catalytic performances of the system.

According to the present invention, the support of the catalytic system comprises alumina; in particular, the support may consist of alumina. According to one embodiment, the support is an alumina oxide, for example Al₂O₃. Thus, the support of the catalytic system may further comprise other components, for example a mixed oxide and/or cerium.

In the context of the present invention, alumina may have any specific surface area (expressed in BET surface m²/g). For example, the specific surface area of alumina is at least 20 m²/g and may in particular vary between 50 and 1,000 m²/g. For example, the specific surface area of alumina is 200 m²/g or 260 m²/g. According to an embodiment of the present invention, the catalyst comprises a support comprising alumina having a specific surface area varying between 50 and 1,000 m²/g, between 100 and 800 m²/g, between 150 and 300 m²/g or between 180 and 250 m²/g.

The preparation of the support of the catalytic system is detailed hereinbelow. The support used in the context of the present invention may also be a commercially-available support.

The catalyst of the present invention also comprises nickel. Nickel of the catalyst according to the present invention may be in any of its oxidation states and in particular in a metal form (under its oxidation state 0) or in an oxide form, its oxidation state II (for example, in the form of nickel (II) oxide (NiO)). Advantageously, the mass content of nickel in the catalytic system may vary between 0.1% and 50% by weight relative to the weight of the support, for example between 0.5% and 40% or between 1% and 30%; preferably, it is lower than 20% or lower than 15%. By “weight of the support”, it should be understood “weight of the support comprising alumina”, including when the support comprises elements other than alumina. In a particularly advantageous manner, the catalytic system comprises 5%+1% by weight of nickel, relative to the weight of the support.

By convention, a catalyst comprising 5% by weight of nickel and 10% by weight of iron, relative to the weight of a support comprising alumina, is denoted by “5Ni10FeAl”, “5Ni10Fe—Al” or “5Ni10Fe/Al”.

The catalyst of the present invention comprises at least one promoter, i.e. one or more promoter(s). Said at least one promoter acts as a dopant and affects the physicochemical, textural as well as conductive properties of the catalyst. Advantageously, the promoter according to the invention has appropriate surface physicochemical properties to assist in fixing the reagent NH₃ as well as appropriate dielectric properties which allow improving the conductivity of the resulting catalyst and which logically lead to the generation of NH₂, NH radicals from NH₃, and then desorption thereof off the catalytic surface, thereby promoting the formation of hydrogen.

The catalyst of the present invention comprises at least one promoter comprising iron (Fe). Iron may be in any oxidation state, and in particular in a metal form or in an oxide form. For example, the iron promoter is in the form of FeO: iron (II) oxide or ferrous oxide, or iron (III) oxide Fe₂O₃ or ferric oxide or in the form of a mixed oxide with NiO and Al₂O₃. An example of a catalyst representative of this embodiment is the catalyst 5Ni10Fe—Al, i.e. a catalyst comprising a support comprising alumina, nickel and a promoter comprising iron.

The catalyst of the present invention may also comprise at least one second promoter. In particular, this second promoter may comprise a chemical element selected from the group consisting of transition metals, alkali metals, alkaline-earths, lanthanides and mixtures thereof. In the context of the present invention, the promoter is in any of its oxidation states and in particular in a metal form or in an oxide form. Thus, according to one embodiment of the present invention, the catalyst comprises at least two promoters, i.e. two promoters or more, for example three or four promoters.

In the context of the present invention, the transition metals may in particular be selected from the group consisting of copper, cobalt, silver, molybdenum, vanadium, manganese, chromium, yttrium, titanium and tantalum. In the case where the second promoter comprises a chemical element that is a transition metal, the latter is preferably cobalt (Co), copper (Cu), silver (Ag) and/or manganese (Mn).

In the context of the present invention, the alkali metals may in particular be selected from the group consisting of lithium, sodium, potassium, rubidium, caesium and francium. In the case where the second promoter comprises a chemical element that is an alkali metal, the latter is preferably potassium (K) or cesium (Cs), and even more preferably potassium (K).

In the context of the present invention, the alkaline-earth metals may in particular be selected from the group consisting of barium, calcium and magnesium. In the case where the second promoter comprises a chemical element that is an alkaline-earth element, the latter is preferably barium (Ba).

In the context of the present invention, the lanthanides may in particular be selected from the group consisting of lanthanum, cerium, praseodymium, neodymium, promethium, samarium, europium, gadolinium, terbium, dysprosium, holmium, erbium, thulium, ytterbium and lutetium. In the case where the second promoter comprises a chemical element that is a lanthanide, the latter is preferably cerium (Ce), gadolinium (Gd) and/or lanthanum (La), and even more preferably cerium (Ce).

According to an embodiment of the present invention, the catalyst comprises at least one second promoter comprising cobalt (Co), manganese (Mn), copper (Cu) and/or silver (Ag).

According to an embodiment of the present invention, the catalyst comprises at least one second promoter comprising lanthanum (la), cerium (Ce) and/or gadolinium (Gd).

According to an embodiment of the present invention, the catalyst comprises at least one second promoter comprising barium (Ba).

According to an embodiment of the present invention, the catalyst comprises at least one second promoter comprising potassium (K).

According to a preferred embodiment, the catalyst of the present invention comprises at least one second promoter comprising cobalt (Co). An example of a catalyst representative of this embodiment is the catalyst 5Ni10Fe1Co—Al, i.e. a catalyst comprising two distinct promoters: a promoter comprising Fe and a promoter comprising Co.

The amount of nickel and/or promoter may be adjusted according to the nature of the used promoter and/or the type of the implemented conversion reaction.

According to an embodiment of the present invention, the mass content of promoter(s) in the catalytic system varies between 0.1% and 40% by weight relative to the weight of the support, for example between 0.2 and 30% by weight, in particular between 0.3% and 20% by weight, preferably between 0.5% and 15% by weight, in particular between 1% and 12% by weight, even more preferably between 2% and 10% by weight relative to the weight of the support.

The promoters used for the preparation of the catalysts of the present invention are in any oxidation state, and in particular in a metal form or in an oxide form. Hence, they may comprise other chemical elements, which are not considered in the calculation of the claimed mass content. For example, for a catalyst 5Ni10Fe1Co—Al, if 1 g of support comprising nickel is used, then 0.049 g of the promoter Co(NO₃)₂·6H₂O are used (molar mass: 291.04 g/mol), which corresponds to 0.01 g of Co (molar mass: 58.93 g/mol), or 1% by weight of cobalt relative to the weight of the support. For this catalyst, the mass content of promoters is 11% by weight relative to the weight of the support, namely 10% of iron (or “iron promoter”) and 1% of cobalt (or “cobalt promoter”).

According to an embodiment of the present invention, the mass content of Fe in the catalytic system varies between 0.1% and 40% by weight relative to the weight of the support, for example between 0.2 and 30% by weight, in particular between 0, 3% and 25% by weight, preferably between 0.5% and 20% by weight, in particular between 1% and 15% by weight, even more preferably between 2% and 10% by weight relative to the weight of the support.

According to an embodiment of the present invention, the mass content of other promoter(s) in the catalytic system (for example a second promoter) varies between 0.1% and 40% by weight relative to the weight of the support, for example between 0, 2 and 30% by weight, in particular between 0.3% and 20% by weight, preferably between 0.5% and 15% by weight, in particular between 1% and 12% by weight, even more preferably between 2% and 10% by weight relative to the weight of the support. For example, besides the promoter comprising Fe, the catalyst according to the invention comprises from 0.5% to 20% by weight of one or more other promoter(s) (% by weight relative to the weight of the support) selected from the group consisting of cobalt (Co), manganese (Mn), copper (Cu), silver (Ag), lanthanum (La), cerium (Ce), gadolinium (Gd), barium (Ba) and potassium (K). According to another example, besides the promoter comprising Fe, the catalyst according to the invention comprises from 0.1% to 4% by weight of cobalt (Co) (% by weight relative to the weight of the support).

According to a particular embodiment of the present invention, the catalyst is doped with two promoters, one of which comprises iron (Fe) and the other one comprises cobalt (Co). This is referred to as a bimetallic catalyst. According to this embodiment, the mass content of iron in the catalyst may preferably vary between 6% and 14%, between 7% and 13% or between 6 and 12%. For example, the mass content of iron in the catalyst is 10%+0.5% by weight relative to the weight of the support. Also, according to this particular embodiment, the mass content of cobalt in the catalyst may preferably vary between 0.1% and 4%, between 0.2 and 3% or between 0.5 and 2%. For example, the mass content of cobalt in the catalyst is 1%+0.5% by weight relative to the weight of the support. An example of a catalyst representative of this embodiment is the catalyst 5Ni10Fe1Co—Al, i.e. a catalyst comprising a support comprising alumina, 5% by weight of nickel relative to the weight of alumina and two distinct promoters: 10% by weight of iron and 1% by weight of cobalt.

The catalyst may be in different forms, for example in the form of beads, monoliths, powders or granules. In the case of powders, the grains forming the powder may for example have an average size comprised between 1 μm and 1 mm, for example between 100 μm and 1 mm, in particular between 200 μm and 800 μm, preferably about 600 μm±20 μm. In particular, the size of the grains may be adapted according to the used production scale. The catalyst may also have a geometric shape, advantageously beads having an average size smaller than 5 cm. The average size of the catalyst is adjusted according to the type as well as the dimensions of the used fixed-bed reactor to avoid any pressure drops.

According to an embodiment of the present invention, the support, nickel and the at least one promoter form a homogeneous mixture. In particular, the support modified by nickel and the promoter form a homogeneous mixture. This means that nickel and the promoter are evenly distributed throughout the entire volume of the catalyst.

According to a preferred embodiment, the catalyst of the present invention comprises:
a support comprising alumina,
nickel,
a promoter comprising iron (Fe), and
optionally at least one second promoter:
   of the transition metal type, and more particularly a promoter comprising cobalt (Co), manganese (Mn), copper (Cu) or silver (Ag);
   of the lanthanide type, and more particularly a promoter comprising lanthanum (La), cerium (Ce) or gadolinium (Gd);
   of the alkaline-earth type, and more particularly a promoter comprising barium (Ba); and/or
   of the alkali metal type, and more particularly a promoter comprising potassium (K).

According to another preferred embodiment, the catalyst of the present invention comprises:
a support comprising alumina,
0.1% to 50% by weight of nickel (% by weight relative to the weight of the support),
0.1% to 40% by weight of promoter(s) (% by weight relative to the weight of the support), including at least one promoter comprising iron (Fe), and optionally at least one second promoter:
   of the transition metal type, and more particularly a promoter comprising cobalt (Co), manganese (Mn), copper (Cu) or silver (Ag);
   of the lanthanide type, and more particularly a promoter comprising lanthanum (La), cerium (Ce) or gadolinium (Gd);
   of the alkaline-earth type, and more particularly a promoter comprising barium (Ba); and/or
   of the alkali metal type, and more particularly a promoter comprising potassium (K).

According to another preferred embodiment, the catalyst of the present invention comprises:
a support comprising alumina,
0.1% to 50% by weight of nickel (% by weight relative to the weight of the support), and
0.1% to 40% by weight of promoter(s) (% by weight relative to the weight of the support), including a promoter comprising iron (Fe), and at least one second promoter selected from among promoters comprising cobalt (Co), manganese (Mn), copper (Cu), silver (Ag), lanthanum (La), cerium (Ce), gadolinium (Gd), barium (Ba) and potassium (K).

According to another preferred embodiment, the catalyst of the present invention comprises:
a support comprising alumina,
0.1% to 50% by weight of nickel (% by weight relative to the weight of the support),
0.5% to 20% by weight of an iron (Fe) promoter (% by weight relative to the weight of the support), and
0.5% to 20% by weight of one or more promoter(s) (% by weight relative to the weight of the support) selected from the group consisting of cobalt (Co), manganese (Mn), copper (Cu), silver (Ag), lanthanum (La), cerium (Ce), gadolinium (Gd), barium (Ba) and potassium (K).

According to another preferred embodiment, the catalyst of the present invention comprises:
a support comprising alumina,
0.1% to 50% by weight of nickel (% by weight relative to the weight of the support),
0.5% to 20% by weight of an iron (Fe) promoter (% by weight relative to the weight of the support), and
0.1% to 4% by weight of a cobalt (Co) promoter (% by weight relative to the weight of the support).

### Catalytic System Preparation Process

The preparation of the catalytic system according to the present invention may be carried out according to different processes.

In particular, the catalytic system may be prepared by a process comprising bringing the support comprising alumina into contact with a nickel precursor and at least one precursor of the promoter (or of the promoters). This step allows forming a solid comprising the support, nickel and the promoter (or the promoters). Optionally, the process comprises a step of calcining the mixture thus obtained. The contact step is possibly preceded by a step of modifying the support. Moreover, the optional calcination step is possibly followed by a step of reducing the calcined mixture.

The step of bringing the support into contact with a nickel precursor and a precursor of the promoter may be carried out for example by impregnation, by coprecipitation or by sol-gel. These three specific embodiments (also so-called sub-variants) are described hereinbelow in more detail.

The nickel precursor and the precursor of the promoter may consist of any chemical compound, or mixture of chemical compounds, containing the metal used as active metal/promoter and more particularly may be a salt of said metal, an oxide of said metal or a mixture thereof, preferably a salt of said metal or a mixture of salts of said metal. The salt (refers to a non-hydrated salt or a hydrated salt, or multi-hydrated salt) of said metal may be selected, for example, from among chloride, nitrate, sulfate, carbonate, acetate, acetylacetonate, tartrate, and citrate of said metal and mixtures thereof, preferably nitrate of said metal. In the case where the promoter is a mixture of several metals, the precursor may be a mixture of different types of salts and/or of oxides of these metals.

The calcination step results in the oxidation of the different components of the catalytic system (support, nickel and promoter). In turn, this optional calcination step may optionally be followed by a reduction step, so as to change the oxidation state of the nickel and of the promoter (to have nickel and metal promoter), and possibly that of the support. The reduction may be total or partial, i.e. only part of the components of the catalytic system can be reduced. The reduction step may be carried out in situ in the non-thermal plasma device under hydrogen.

According to a first variant of the process according to the invention, the catalytic system preparation process according to the invention comprises:
a step of bringing the support comprising alumina into contact with a nickel precursor and one or more precursor(s) of the promoter, and
optionally, a step of calcining the mixture obtained following contact of the components,
optionally, a step of reducing the calcined mixture obtained in the previous step.

According to a second variant of the process according to the invention, the catalytic system preparation process according to the invention comprises:
a step of bringing the support comprising alumina into contact with a nickel precursor and one or more precursor(s) of the promoter, and
a step of calcining the mixture obtained following contact of the components,
optionally, a step of reducing the calcined mixture obtained in the previous step.

According to a third variant of the process according to the invention, the catalytic system preparation process according to the invention comprises:
a step of bringing the support comprising alumina into contact with a nickel precursor and one or more precursor(s) of the promoter, and
a step of calcining the mixture obtained following contact of the components,
a step of reducing the calcined mixture obtained in the previous step.

According to a fourth variant of the process according to the invention, the catalytic system preparation process according to the invention comprises:
a step of modifying the support comprising alumina, and
a step of bringing the modified support into contact with a nickel precursor and one or more precursor(s) of the promoter,
optionally a step of calcining the mixture obtained following contact of the components,
optionally, a step of reducing the calcined mixture obtained in the previous step.

In particular, the step of bringing the components into contact may be carried out by impregnation. More specifically, according to this first sub-variant, the method comprises the following steps:
1) a step of preparing the support, and
2) a step of bringing the components into contact by impregnation.

In turn, step 1) of preparing a support comprises the following sub-steps:
1.1) preparation of a suspension comprising an alumina precursor or comprising an alumina oxide precursor.
According to this step 1.1), the support precursor corresponds to an alumina precursor or a mixture of several precursors. In the case where the support is a mixture, in particular a mixed oxide, of cerium and alumina, a cerium precursor suspension and an alumina precursor suspension are advantageously prepared separately and then mixed in a ratio allowing obtaining the desired molar ratio Ce/Al in the final mixture, in particular the mixed oxide, of cerium and alumina.
1.2) mixing of the suspension resulting from step 1.1).
In particular, the addition of these precursors is done at room temperature, for example between 2° and 25° C., with continuous mixing, for 30 min to several hours, for example for 30 min to 3 h.
1.3) recovery of the solid obtained in step 1.2) by removal of the excess water, in particular by evaporation of the water or filtration, and then drying of the resulting solid.
In particular, the drying step may be carried out at a temperature lower than 150° C. typically at a temperature of about 100° C., for example for a time period varying between 5 h and 48 h.
1.4) calcination of the solid resulting from step 1.3) to result in the support.
The product resulting from step 1.3) is calcined, for example at a temperature comprised between 300° C. and 600° C. This calcination step may be carried out for 3 h or more, for example for a time period varying between 3 h to 6 h. This step causes the thermal decomposition of the nitrates in order to obtain oxides.

In turn, step 2) of bringing the components into contact comprises the following sub-steps:
2.1) preparation of an aqueous suspension comprising a nickel precursor and one or more precursor(s) of the promoters.
During this step, an appropriate mass of each precursor is added to an appropriate volume of solvent, for example water. By “appropriate mass” and “appropriate volume”, it should be understood the appropriate amounts of precursors and of solvent (in particular water) to obtain the desired mass contents of nickel and of promoter in the final catalytic system.
2.2) addition of the support resulting from step 1) to the aqueous solution resulting from step 2.1) to result in a suspension.
2.3) mixing of the suspension resulting from step 2.2).
The addition of these precursors is done at room temperature, for example between 2° and 25° C., with continuous mixing, for 30 min to several hours, for example for 30 min to 3 h.
2.4) recovery of the solid comprising the support, the nickel and the promoters obtained in step 2.3) by removal of the excess water, in particular by evaporation of the water or filtration, and then drying of the resulting solid.
For example, the drying step may be carried out at a temperature lower than 150° C., typically at a temperature of about 100° C., for example for a time period ranging from 7 h to 48 h.
2.5) calcination of the solid resulting from step 2.4) to result in the catalytic system.
The product resulting from step 2.4) is calcined, for example at a temperature comprised between 300° C. and 600° C. This calcination step may be carried out for 3 h or more, for example for a time period varying between 3 h to 6 h. This step causes the thermal decomposition of the nitrates in order to obtain oxides.

This first sub-alternative is also so-called wet impregnation process. It consists in impregnating the support with the nickel precursor and the precursor of the promoter.

Alternatively, the step of bringing the components into contact may be carried out by co-precipitation. More specifically, according to a second sub-variant, the catalytic system preparation process comprises:
1′) a step of preparing a support, and
2′) a step of bringing the support into contact with a nickel precursor and the promoter, this contact being carried out by co-precipitation.

Step 1′) of preparing the support consists in preparing an aqueous solution comprising a nickel precursor and the precursors of the promoters. This step is identical to step 2.1) of the previously-described wet impregnation process.

In turn, step 2′) of bringing the components into contact comprises the following sub-steps:
2.1′) addition of the support to the solution resulting from step 1′) to result in a suspension
This step is identical to step 2.2) of the previously-described wet impregnation process.
2.2′) addition of a base to the resulting suspension of step 2.1′).
During this step, a base is added to the suspension resulting from step 2.1′). Advantageously, this base is a hydroxide salt, such as sodium hydroxide, potassium hydroxide, sodium carbonate or potassium carbonate, preferably sodium hydroxide. It may be used in the form of a solution, in particular aqueous. The base is progressively added drop-by-drop until the pH of the suspension (consisting of a solid in suspension in a liquid solution) is comprised between 8 and 12, preferably equal to about 10. Step 2.2′) may be carried out at a temperature comprised between 60° C. and 100° C., in particular between 70° C. and 90° C., preferably equal to about 80° C.
2.3′) mixing of the suspension resulting from step 2.2′).
This step aims to precipitate the nickel hydroxide and the hydroxide of the metal used as a promoter at the surface of the support. For example, mixing, in particular by stirring, is carried out at a temperature comprised between 60° C. and 100° C., preferably equal to about 80° C. This mixing step may be carried out for a time period of 2 h or more, typically for about 3 h.
2.4′) recovery of the solid comprising the support, nickel and the promoter obtained in step 2.3′) and calcination thereof to lead to the catalytic system.
This step is identical to step 2.5) of the wet impregnation process.

This second sub-variant allows precipitating nickel hydroxide and hydroxide of the metal used as a promoter at the surface of the support.

The step of bringing the components into contact may also be carried out by sol-gel reaction. More specifically, according to a third sub-variant, the step of bringing the support into contact with a nickel precursor and a precursor of the promoter is carried out by sol-gel reaction and comprises the following sub-steps:
1″) preparing a solution comprising a nickel precursor, a precursor of the promoter (or of the promoters) and a support precursor in citric acid,
2″) adjusting the pH of the solution 1″), for example at 4, by preferably adding a strong base solution of NaOH,
3″) reflux heating the solution of step 2″), and
4″) removing the excess citric acid and recovering the catalytic system.

In step 1″), the support precursor corresponds to an alumina precursor, a cerium precursor, a lanthanum precursor or a mixture of an alumina precursor, cerium and a lanthanum precursor depending on whether the support is alumina, cerium, lanthanum or a mixture of alumina, cerium and lanthanum. In the case where the support is a mixture, in particular a mixed oxide, of alumina, cerium and lanthanum, a solution of an alumina precursor, cerium and a solution of a lanthanum precursor are advantageously prepared separately and then mixed in a ratio allowing obraining the desired Al/Ce as well as Ce/La molar ratio in the final mixture, in particular the mixed oxide, of cerium and lanthanum alumina.

In order to prepare the desired amount of the catalyst, the precursor of the support, as well as the nickel precursors (for example, the nickel (II) tetrahydrate acetate) and the promoter are advantageously dissolved separately in citric acid, in particular with heating (for example, at 80-120° C. in particular at about 80° C., for 1 h or more, for example for about 2 h).

The reflux heating step 3″) is carried out for a time period sufficient to obtain the gel.

If the product resulting from step 3″) is a gel, it may be dried in an oven or solidified before performing a possible calcination step, in particular using liquid nitrogen, so that the product resulting from step 3″) is a solid.

The last step 4″) consists in recovering the solid obtained in step 3″), this step is identical to step 2.5) of the wet impregnation process.

The support used in the preparation process of the catalytic system may also be a commercially-available support.

### Use of the Catalyst According to the Present Invention

The present invention also relates to the use of the catalyst according to the invention for converting a gas or a mixture of gases comprising ammonia (NH₃), said conversion being carried out in the presence of cold plasma.

The present invention relates in particular to the combined use of the catalyst of the present invention, as well as a cold plasma, preferably a plasma generated by dielectric barrier discharge (DBD), for converting a gas or a mixture of gases comprising NH₃.

In other words, the present invention relates in particular to the use of the catalyst of the present invention, activated by a cold plasma, preferably a plasma generated by dielectric barrier discharge (DBD), for converting a gas or a mixture of gases comprising NH₃.

Indeed, the Inventors have realized that the combination of a catalyst according to the present invention, and of a cold plasma, preferably a plasma generated by dielectric barrier discharge (DBD), resulted in an increased efficiency for converting a gas or a mixture of gases comprising NH₃ and/or for the production of hydrogen, for example for the production of dihydrogen (H₂) and gaseous dinitrogen (N₂).

The present invention also relates to the use of the catalytic system according to the invention for the production of dihydrogen (H₂) and dinitrogen (N₂), from a gas or a mixture of gases comprising NH₃.

The present invention relates in particular to the combined use of the catalyst of the present invention, as well as a cold plasma, preferably a plasma generated by dielectric barrier discharge (DBD), for the production of dihydrogen (H₂) and dinitrogen (N₂), from a gas or a mixture of gases comprising NH₃.

The present invention relates in particular to the use of the catalyst of the present invention, activated by a cold plasma, preferably a plasma generated by dielectric barrier discharge (DBD), for the production of dihydrogen (H₂) and dinitrogen (N₂), from a gas or a mixture of gases comprising NH₃.

### List of the Cited Documents

[1] Yoshitsugu Kojima, Masakuni Yamaguchi, Ammonia as a hydrogen energy carrier, International Journal of Hydrogen Energy, 2022, ISSN 0360-3199, https://doi.org/10.1016/j.ijhydene.2022.05.096.
[2] Schüth, F. and Palkovits, R. and Schlögl, R. and Su, D. S., Ammonia as a possible element in an energy infrastructure: catalysts for ammonia decomposition, Energy Environ. Sci., 2012, Volume 5, p. 6278-6289, http://dx.doi.org/10.1039/C2EE02865D.
[3] Dejiang Zhou; Renwu Zhou; Rusen Zhou; Baowang Liu; Tianqi Zhang; Yubin Xian; Patrick J. Cullen; Xinpei Lu; Kostya (Ken) Ostrikov; (2021). Sustainable ammonia production by non-thermal plasmas: Status, mechanisms, and opportunities. Chemical Engineering Journal, ( )-. https://doi.org/doi: 10.1016/j.cej.2021.129544
[4] M. Mikhail et al., “Tailoring physicochemical and electrical properties of Ni/CeZrOx doped catalysts for high efficiency of plasma catalytic CO₂ methanation”, Appl. Catal. B Environ., vol. 294, p. 120233, October 2021, https://doi.org/10.1016/j.apcatb.2021.120233
[5] M. Mikhail et al., “Electrocatalytic behaviour of CeZrOx-supported Ni catalysts in plasma assisted CO₂ methanation”, Catal Sci Technol, vol. 10, no 14, p. 4532-4543, 2020, https://doi.org/10.1039/DOCY00312C
[6] Mao Akiyama, Keigo Aihara, Tomiko Sawaguchi, Masahiko Matsukata, Masakazu Iwamoto, Ammonia decomposition to clean hydrogen using non-thermal atmospheric-pressure plasma, International Journal of Hydrogen Energy, Volume 43, Issue 31, 2018, Pages 14493-14497, ISSN 0360-3199, https://doi.org/10.1016/j.ijhydene.2018.06.022.
[7] Mostafa El-Shafie, Shinji Kambara, Yukio Hayakawa, Plasma-enhanced catalytic ammonia decomposition over ruthenium (Ru/Al₂O₃) and soda glass (SiO2) materials, Journal of the Energy Institute, Volume 99, 2021, Pages 145-153, ISSN 1743-9671, https://doi.org/10.1016/j.joei.2021.09.001.
[8] Lucentini et al., “Review of the decomposition of ammonia to generate hydrogen” Ind. Eng. Chem. Res. 2021,60, 18560-18611, https://doi.org/10.1021/acs.iecr.1c00843
[9] Patent application CN 101147863 A
[10] Patent application EP 2 332 646 A1
[11] Patent application WO 2021/255422 A1
[12] Yanhhui Yi et al., Plasma-assisted ammonia decomposition over Fe—Ni alloy catalysts for COₓ-free hydrogen” AIChE J, 65:691-701, 2019, https://doi.org/10.1002/aic.16479

### Examples

The invention is now described in more detail with reference to the following examples, intended for an illustrative purpose and not to limit the scope of the invention.

### A. Preparation of the Different Catalytic Systems by Wet Impregnation

Several supports have been used to prepare various catalytic systems identified more specifically in Table 1 hereinbelow:
1) A commercial alumina oxide (Al200, Specific surface area=200 m²/g, Saint Gobain);
2) A commercial alumina oxide (Al260, Specific surface area=260 m²/g, Saint Gobain);
3) A commercial cerin-zirconia mixed oxide from Sigma Aldrich (CZ);
4) A commercial silica oxide SiO2 (Si160, Specific surface area=160 m²/g, Saint Gobain);
5) A commercial magnesium oxide MgO from Sigma Aldrich;
6) A mixed oxide synthesized by the Inventors according to the previously-described process.

The different catalysts given herein as examples are prepared by wet impregnation.

The nickel catalytic systems doped with the promoter (metal M) have been prepared by the process from an aqueous solution of Ni(NO₃)₂·6H₂O (Sigma-Aldrich) and of one or more promoter precursor(s) selected from among: Fe(NO₃)₂·9H₂O, Co(NO₃)₂·6H₂O, Mn(NO₃)₂·4H₂O, La(NO₃)₂·6H₂O, Y(NO₃)₂·6H₂O, Gd(NO₃)₃·6H₂O, Ba(NO₃)₂, Ag(NO₃), Cs(NO₃), Ce(NO₃)₃·6H₂O, Cu(NO₃)₂·5H₂O, NaNO₃, and KNO₃ (all available on the market, Sigma-Aldrich), depending on the desired promoter.

For example, for the preparation of the catalyst 5Ni10Fe—Al (one of the catalysts according to the invention), the nickel content is 5% by weight relative to the weight of the support and that of the Fe promoter is 10% by weight relative to the weight of the support.

The appropriate mass of nickel salt and that of the promoter precursor are dissolved in a volume of water of 50 mL, at room temperature and under stirring. The appropriate mass of support is added to the aqueous solution containing the mixture of the metal salts and kept under stirring for 2 hours. For example, 0.25 g of nickel nitrate (which represents a content of 5% by weight of nickel relative to the weight of the support), 0.72 g of iron nitrate (which represents a content of 10% by weight of iron relative to the weight of the support), and 1 g of support are mixed according to the previous procedure. The mixture is then placed in a rotary evaporator at 60° C., in order to remove the excess water.

After impregnation and evaporation of the water, all samples are collected, dried in an oven at 100° C. for 8 h, and then calcined in air at 550° C. for 4 h with a temperature ramp of 10° C./min. After calcination, the samples of the catalytic system are hand-ground and screened to an average grain size comprised between 50 and 200 μm.

The different catalysts prepared according to the above-described method are listed in Table 1 hereinbelow.

### B. Conversion of the Gas Comprising NH₃ in the Presence of the Different Catalysts

The procedure for the production of hydrogen by means of a catalytic plasma reactor is as follows: 320 mg of catalyst to be tested, corresponding to a GHSV (Gas Hourly Space Velocity) of 22,000 h⁻¹, are placed between the electrodes of the DBD reactor; the reactor is supplied with an ammonia gas with a total flow rate of 160 mL/min STP (Standard Temperature and Pressure), at atmospheric pressure and at a temperature of 20° C.

A non-thermal dielectric barrier discharge (DBD) plasma is created between two electrodes: a cylindrical electrode made of copper placed inside a tube made of alumina (3 mm of diameter), surrounded by a coaxial tube made of quartz (10 mm of inner diameter, 1 mm of thickness), and a steel wire wound around the external surface of the tube made of quartz, acting as a ground electrode (grounded via an outer capacitor of 2 nF). In this configuration, a discharge is sustained in a space of 2.5 mm, covering a length of about 1 cm. Before the catalytic test, the catalytic systems as synthesized are reduced in situ under non-thermal DBD plasma under H₂ as a discharge gas for a duration of 60 minutes.

The activity and selectivity of the catalysts with and without promoter under DBD plasma conditions are assessed in an experimental device comprising a tubular cylindrical reactor made of quartz, a DBD plasma generator, and the corresponding devices for the supply and analysis of the gases.

Without plasma, no modification of the composition of the outlet gases is observed. When the plasma is ignited, and after stabilization, a production of hydrogen as well as dinitrogen is obtained at the outlet.

The following equations have been used to estimate the catalytic performance and calculate the conversion of NH₃, and the selectivity of H₂ and N₂:

$${X}_{N {H}_{3}} ( \% ) = \frac{{F}_{N {H}_{3}}^{i n} - {F}_{N {H}_{3}}^{o u t}}{{F}_{N {H}_{3}}^{i n}} \times 100 \qquad ( Eq . 2 )$$

$${S}_{H 2} ( \% ) = \frac{{F}_{{H}_{2}}^{o u t}}{{F}_{N {H}_{3}}^{i n} - {F}_{N {H}_{3}}^{o u t}} \times 100 \qquad ( Eq . 3 )$$

$${S}_{N 2} ( \% ) = \frac{{F}_{{N}_{2}}^{o u t}}{{F}_{N {H}_{3}}^{i n} - {F}_{N {H}_{3}}^{out}} \times 100 \qquad ( Eq . 4 )$$

where Fⁱⁿ and F^{out} respectively designate the inlet and outlet flow rate (mol/s) of the considered species at the inlet and at the outlet of the reactor.

### C. Results

Table 1 hereinbelow illustrates and summarizes a list of the tested catalysts and shows the results of the catalytic activity obtained in terms of NH₃ conversion, and H₂ and N₂ selectivity.

TABLE 1

| | | NH₃ conversion | H₂ selectivity | N₂ selectivity |
|---|---|---|---|---|
| 1c | 13Ni-CZ | 30.7% | 66.5% | 33.5% |
| 2c | 10Ni5Ce-Al200 | 22.6% | 66.7% | 33.3% |
| 3c | Ce/LaNi-AlO | 48.9% | 74.5% | 25.5% |
| | mixed oxides | | | |
| 4c | 2Ni8La-Al200 | 5.8% | 74.7% | 25.3% |
| 5c | 6Ni-MgO | 2.2% | 66.8% | 33.1% |
| 6i | 2Ni8Fe-Al200 | 89.8% | 74.2% | 25.8% |
| 7i | 10Ni8Fe-Al200 | 68.7% | 74.3% | 25.7% |
| 8c | 15Ni4Gd-Al200 | 1.7% | 73.6% | 26.4% |
| 9i | 2Ni4La4Fe-Al200 | 85.7% | 74.2% | 25.8% |
| 10i | 2Ni8Fe1Cs-Al200 | 74.1% | 74.2% | 25.8% |
| 11c | 10Ni8Ba-Al200 | 62.5% | 74.3% | 25.7% |
| 12i | 5Ni10Fe-Al200 | 99.8% | 74.3% | 25.7% |
| 13i | 5Ni10Fe1Co-Al200 | 98.9% | 74.1% | 25.9% |
| 14i | 5Ni10Fe1La-Al200 | 94.6% | 74.1% | 25.9% |
| 15i | 5Ni10Fe1Ce-Al200 | 93.4% | 74.1% | 25.9% |
| 16i | 5Ni10Fe1K-Al200 | 78.6% | 74.2% | 25.8% |
| 17i | 5Ni10Fe1Ba-Al200 | 88.2% | 74.1% | 25.9% |
| 18i | 5Ni10Fe1Cu-Al200 | 77.5% | 74.2% | 25.8% |
| 19i | 5Ni10Fe1Mn-Al200 | 87.5% | 74.2% | 25.8% |
| 20i | 5Ni10Fe-Al260 | 84.8% | 74.2% | 25.8% |
| 21c | 5Ni10Fe-Si160 | 86.9% | 74.2% | 25.8% |

FIG. 1 illustrates the GC chromatogram of the incoming gas before reaction (containing 100% NH₃) by combining the 5Ni10FeAl catalytic system (catalyst 12i in table 1 hereinabove) with the DBD plasma catalytic reactor.

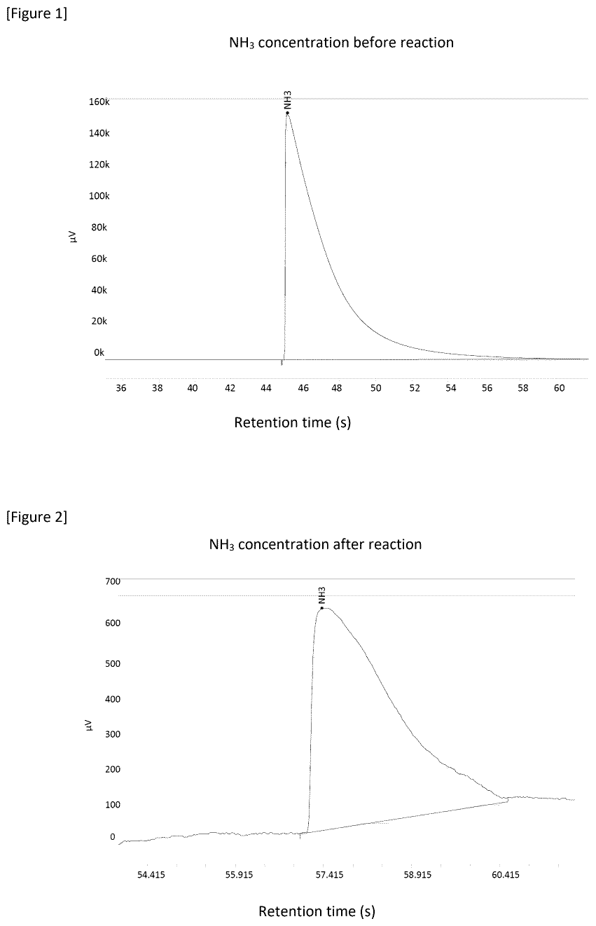

FIG. 2 illustrates the GC chromatogram of the ammonia gas remaining after reaction following the conversion of NH₃ by combining the 5Ni10FeAl catalytic system (the catalyst 12i in Table 1 hereinabove) with the DBD plasma catalytic reactor.

1. A process for converting a gas or a mixture of gases comprising ammonia (NH₃) into dihydrogen (H₂) and dinitrogen (N₂) according to the following reaction:
$${NH}_{3} \to \frac{3}{2} {H}_{2} + \frac{1}{2} {N}_{2}$$
characterized in that it is carried out in the presence of cold plasma and a catalyst comprising:
a support comprising alumina,
nickel, and
at least one promoter comprising iron (Fe).

2. The process according to claim 1, according to which the catalyst further comprises at least one second promoter:
of the transition metal type, and more particularly a promoter comprising cobalt (Co), manganese (Mn), copper (Cu) or silver (Ag);
of the lanthanide type, and more particularly a promoter comprising lanthanum (La), cerium (Ce) or gadolinium (Gd);
of the alkaline-earth type, and more particularly a promoter comprising barium (Ba); and/or
of the alkali metal type, and more particularly a promoter comprising potassium (K).

3. The process according to claim 1, according to which:
the mass content of promoter(s) in the catalyst varies between 0.1% and 40% by weight relative to the weight of the support, preferably between 0.5% and 20% by weight; or
the mass content of iron in the catalyst varies between 0.1% and 40% by weight relative to the weight of the support, preferably between 0.5% and 20% by weight.

4. The process according to claim 1, according to which the catalyst comprises at least one second promoter comprising cobalt (Co).

5. The process according to claim 1, according to which:
the mass content of iron varies between 6 and 14% relative to the weight of the support; and/or
the mass content of cobalt varies between 0.1% and 4% relative to the weight of the support.

6. The process according to claim 1, according to which the support is an alumina oxide.

7. The process according to claim 1, according to which the mass content of nickel in the catalyst varies between 0.1% and 50% by weight relative to the weight of the support, preferably is lower than 20%.

8. The process according to claim 1, according to which the cold plasma is generated by dielectric barrier discharge (DBD).

9. The process according to claim 1, according to which the catalyst comprises:
a support comprising alumina,
0.1% to 50% by weight of nickel (% by weight relative to the weight of the support), and
0.1% to 40% by weight of promoter(s) (% by weight relative to the weight of the support), including an iron (Fe) promoter, and at least one second promoter selected from among cobalt (Co), manganese (Mn), copper (Cu), silver (Ag), lanthanum (La), cerium (Ce), gadolinium (Gd), barium (Ba) and potassium (K).

10. A catalyst for the conversion of a gas or a mixture of gases comprising ammonia (NH₃) into dihydrogen (H₂) and dinitrogen (N₂) according to the following reaction:
$${NH}_{3} \to \frac{3}{2} {H}_{2} + \frac{1}{2} {N}_{2}$$
the conversion being carried out in the presence of a cold plasma, characterized in that the catalyst comprises:
a support comprising alumina,
nickel, and
at least one promoter comprising iron (Fe).

11. The catalyst according to claim 10, further comprising at least one second promoter:
of the transition metal type, and more particularly a promoter comprising cobalt (Co), manganese (Mn), copper (Cu) or silver (Ag);
of the lanthanide type, and more particularly a promoter comprising lanthanum (La), cerium (Ce) or gadolinium (Gd);
of the alkaline-earth type, and more particularly barium (Ba); and/or
of the alkali metal type, and more particularly potassium (K).

12. The catalyst according to claim 10, according to which the mass content of promoter(s) in the catalyst varies between 0.1% and 40% by weight relative to the weight of the support, preferably between 0.5% and 20% by weight.

13. The catalyst according to claim 10, comprising:
0.1% to 50% by weight of nickel (% by weight relative to the weight of the support),
0.5% to 20% by weight of iron (Fe) (% by weight relative to the weight of the support), and
0.5% to 20% by weight of one or more promoter(s) (% by weight relative to the weight of the support) selected from the group consisting of cobalt (Co), manganese (Mn), copper (Cu), silver (Ag), lanthanum (La), cerium (Ce), gadolinium (Gd), barium (Ba) and potassium (K).

14. The catalyst according to claim 10 any one of claims 10 to 13, comprising at least one second promoter comprising cobalt (Co), according to which:
the mass content of iron varies between 6 and 14% relative to the weight of the support; and/or
the mass content of cobalt varies between 0.1% and 4% relative to the weight of the support.

15. (canceled)

16. A process for converting a gas or a mixture of gases comprising ammonia (NH₃), said conversion being carried out in the presence of a catalyst and in the presence of cold plasma, preferably a plasma generated by dielectric barrier discharge (DBD), wherein the catalyst comprises:
a support comprising alumina,
nickel, and
at least one promoter comprising iron (Fe).

17. The process according to claim 16, wherein the catalyst comprises at least one second promoter:
of the transition metal type, and more particularly a promoter comprising cobalt (Co), manganese (Mn), copper (Cu) or silver (Ag);
of the lanthanide type, and more particularly a promoter comprising lanthanum (La), cerium (Ce) or gadolinium (Gd);
of the alkaline-earth type, and more particularly barium (Ba); and/or
of the alkali metal type, and more particularly potassium (K).

18. The process according to claim 16, according to which the mass content of promoter(s) in the catalyst varies between 0.1% and 40% by weight relative to the weight of the support, preferably between 0.5% and 20% by weight.

19. The process according to claim 16, wherein the catalyst comprises:
0.1% to 50% by weight of nickel (% by weight relative to the weight of the support),
0.5% to 20% by weight of iron (Fe) (% by weight relative to the weight of the support), and
0.5% to 20% by weight of one or more promoter(s) (% by weight relative to the weight of the support) selected from the group consisting of cobalt (Co), manganese (Mn), copper (Cu), silver (Ag), lanthanum (La), cerium (Ce), gadolinium (Gd), barium (Ba) and potassium (K).

20. The process according to claim 16, wherein the catalyst comprises at least one second promoter comprising cobalt (Co), according to which:
the mass content of iron varies between 6 and 14% relative to the weight of the support; and/or
the mass content of cobalt varies between 0.1% and 4% relative to the weight of the support.
